(19) United States
(12) Patent Application Publication
(10) Pub. No.: US 2007/0026841 A1
(43) Pub. Date: Feb. 1, 2007

(54) Apparatus and method for automatic characteristic configuration in digitized radio systems

(76) Inventor: Robert G. DeMoor, Sugar Land, TX (US)

Correspondence Address: TEXAS INSTRUMENTS INCORPORATED, P O BOX 655474, M/S 3999, DALLAS, TX, 75265, US

(21) Appl. No.: 11/189,316

(22) Filed: Jul. 26, 2005

(51) Int. Cl. H04B 1/06

(52) U.S. Cl. 455/352

(57) ABSTRACT

In structure of selected category of broadcast signals, one channel includes the category of program material transmitted by the station. When the signals having this category designation are applied to the receiver unit, the receiver unit can identify these program categories and, using parameters designated for each category of program material, can process the program material thereby providing an output signal customized for the program material currently being received by the radio receiver.

### BACKGROUND OF THE INVENTION

1. Field of the Invention

This invention relates generally to radio receivers capable of decoding digitals signals and, for particularly, to setting of radio receiver characteristics in response to information in the broadcast signals.

2. Background of the Invention

The configuration of an automobile radio's performance characteristics (e.g., stereo separation versus radio frequency (RF) signal strength, audio bandwidth versus in-band noise level, etc) is typically set by the manufacturer based on an average buyer profile for a specific type of vehicle. For instance, the buyer of a Lincoln Continental is assumed to be more likely to listen to classical music than the buyer of Ford Mustang convertible, the latter being assumed to be more likely to listen to rock music. Consequently, the radio in the Lincoln Continental is configured by the manufacturer to sound better when playing classical music than a similar radio in a Ford Mustang convertible. Similarly, the radio in the Ford Mustang convertible is configured to sound better when playing rock music. Specifically, the radio in the Lincoln Continental may be configured to blend aggressively from stereo to mono under marginal signal conditions in order to minimize the amount of audio static (background noise) in the output signal applied to the speakers (i.e., less static is present in a mono signal than in a stereo signal). In the case of classical music, which characteristically has a large audio dynamic range, it is desirable not to have background static, especially with audio content at a low level. In the case of rock music, a relatively larger level of background static usually can not be heard over the program content. It is therefore preferable to maximize the stereo separation.

While the technique of setting the characteristics of the audio system to the average owner of the automobile provides reasonable compromise for audio performance, the solution is far less than ideal. The purchaser of an automobile may not fit the “general” profile for that particular automobile so that the purchaser may be disappointed with the resulting audio. Even those owners who fit the profile associated with their automobiles are typically not going to listen exclusively to one type of audio program. When the audio program is not audio program of the general profile, the user/owner can be dissatisfied.

A need has therefore been felt for apparatus and an associated method having the feature of providing more flexibility in selecting the parameters for an audio program. It would be yet another feature of the apparatus and associated method to provide customized parameters for the audio program. It would be a still further feature of the apparatus and associated method to provide customized parameters for each audio program played over the radio. It would be more particular feature of the apparatus and associated method to provide customized parameters for each audio program played by a radio receiver based on information included in the broadcast radio signal.

### SUMMARY OF THE INVENTION

The foregoing and other features are accomplished, according the present invention, by using program identification information transmitted along with the broadcast program material to identify a group of parameters to be used in processing the program material. The receiver, in response to the identification of the parameter group, retrieves the parameters from storage and processes the program material with the retrieved parameters. In this manner, the processing of each audio program can be customized to the audio performance being transmitted.

Other features and advantages of present invention will be more clearly understood upon reading of the following description and the accompanying drawings and the claims.

### BRIEF DESCRIPTION OF THE DRAWINGS

FIG. 1 illustrates the components of the RDS/RBDS transmission spectrum according to the prior art.

FIG. 2 is a block diagram of radio receiver capable of customizing the performance of program material in a radio transmission according to the present invention.

FIG. 3 illustrates the technique for processing broadcast band information according to the present invention.

### DESCRIPTION OF THE PREFERRED EMBODIMENT

### 1. Detailed Description of the Figures

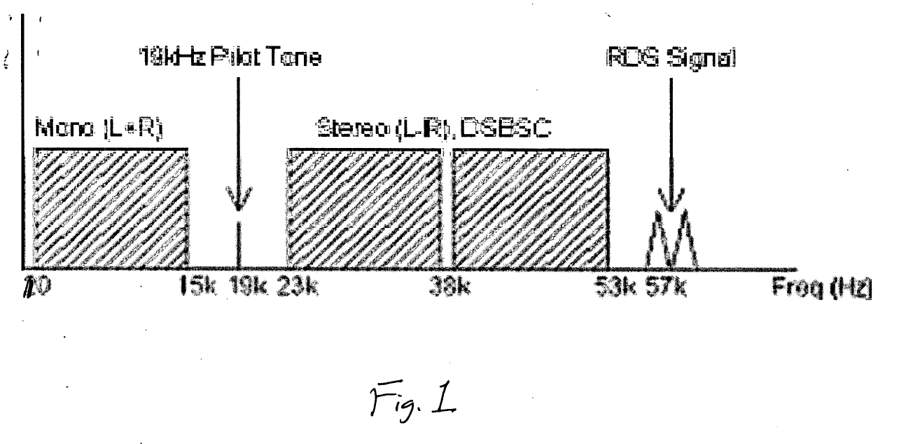

Referring to FIG. 1, the spectrum of an FM/RDS signal capable of being used in conjunction with the present invention is shown. The pilot tone is positioned at 19 kHz. The mono program material, the sum of the left and right stereo program material, is transmitted in the broadcast band ranges from 10 kHz to 15 kHz when the pilot tone is transmitted at 19 kHz. The double-sideband, suppressed carrier (DSBSC) is centered around 38 kHz, i.e., twice the pilot tone frequency. The left and right stereo program components extend from 38 kHz to 23 kHz and from 38 kHz to 53 kHz respectively. The RDS or program type signal is centered around 57 kHz. The RDS signal includes information concerning the type of audio material (e.g., music programs which the station broadcasts, i.e., classical, soft rock, jazz, etc.)

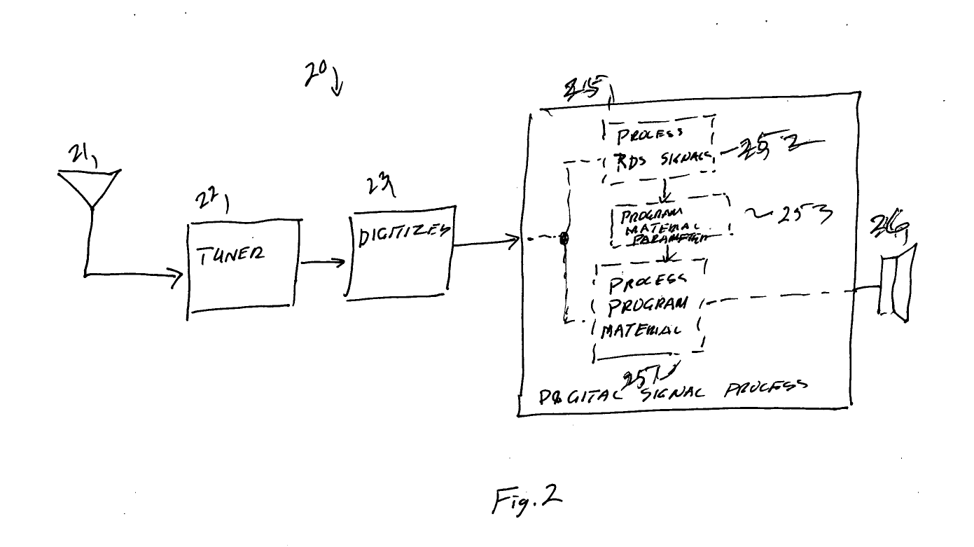

Referring to FIG. 2, a receiver 20 capable of implementing the present invention is illustrated. An antenna 21 receives broadcast signals from a station. The broadcast spectrum, i.e., of the broadcast band, is selected by the tuner 22 through the use of an intermediate frequency (IF). The output signal from the tuner 22 is applied to a digitizer 23 where the signals are converted to a digital format. The digitized signals of the broadcast band are then applied to a digital signal processor 25. In the digital signal processor 25, the digitized broadcast signals are separated into the program material signals and the RDS signals. The program material signals are processed by procedure 251. The RDS signals are processed by procedure 252. A portion of the procedure 252 is to determine the category of the program material transmitted by the by the station. When this category is determined, then the procedure applies parameters that are used in procedure 251. The parameters determined by the broadcast signals include parameters that in the prior art would be installed in the receiver by the factory. In the present procedure, a plurality of sets of parameters are available, each set of parameters optimizing the processing of program material enhances by the associated parameters.

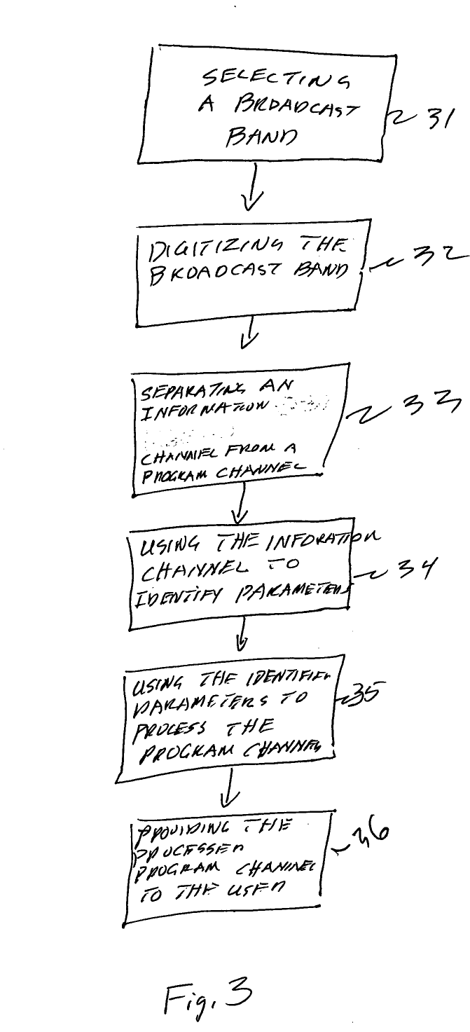

Referring to FIG. 3, the processing of a broadcast band begins with selecting a broadcast in step 31. In the present invention, the broadcast band typically includes a program channel and an information channel. The information channel typically includes the type of programming that the transmitting station normally broadcasts. In step 32, the selected broadcast is digitized. The digitization of the broadcast band permits a processing unit to process the broadcast band, an activity that would be difficult with analog signals. The information channel and the broadcast channel are separated in step 33. This separation permits each of the channels to be processed separately. In step 34, the information channel is processed to identify a group of parameters. For example, the identification of the type of programming in the information channel can be used to reference the parameters relevant to the program channel. In step 35, the identified parameters are used to process the program channel signals for optimum user enjoyment. In step 36, the processed program channel is provided to the user, typically by applying the processed program material to a speaker.

### 2. Operation of the Preferred Embodiment

The information in the RDS channel is typically used to assist the user in selecting a channel by providing the user with content that summarizes the type of material broadcast by the station. The present invention uses this broadcast band information to select a set of parameters that enhances the performance of the program content provided by the station. The set of parameters is used to process the program material of the station providing the program content information. When a new station is accessed, the program content information in the broadcast band of the newly accessed station is used to access parameters related to the new content.

Some of the parameters that are important in the listening experience of a piece of audio program material can include, but are limited to, stereo separation thresholds, audio bandwidth shaping thresholds, soft mute thresholds and preselection filter thresholds (i.e., the adjustment of the bandwidth of the IF signal in the digital domain.)

In the foregoing discussion, the RDS signal includes an identification of the type of programming material transmitted by the station. In the present invention, use is made of information in the RDS channel that identifies the type of program material broadcast by station. However, as will be clear the RDS channel has the ability to specify the category of the current piece of program material. Thus, the parameters for each program piece can be specified providing a greater customization of the program performance. A still further improvement would be to have parameters transmitted along with each unit of program material. In this manner, the program performance can be further customized for individual performance materials.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A processing unit responsive to digitized radio signals, the processing unit comprising:
a first procedure for processing the digitized radio signals, the first procedure identifying a category of program material;
a second procedure responsive to the category of program material identified by the first procedure, the second procedure determining parameters for processing the program material; and
a third procedure responsive to the parameters, the third procedure using the parameters to process the program material.

2. The processing unit as recited in claim 1 wherein the broadcast signal is a double side band, suppressed carrier signal.

3. The processing unit as recited in claim 1 wherein the category of program materials is included in the program type channel.

4. The processing unit as recited in claim 1 wherein the program material is an audio program.

5. The processing unit as recited in claim 1 wherein a category of program material is broadcast for each unit of program material.

6. The method of processing program material in broadcast signals, the broadcast signals including a program channel and an information channel, the method comprising:
processing the information channel to determine the category of the program material transmitted with the information channel;
based on the category of the program material transmitted with the program material, selecting processing parameters; and
using the selected processing parameters, processing the program material.

7. The method as recited in claim 6 further comprising broadcasting an audio program in the program channel.

8. The method as recited in claim 5 further comprising applying the processed material to a speaker.

9. The method as recited in claim 6 further comprising broadcasting a category of program material for each program material segment.

10. A radio receiver, the receiver responsive to broadcast bands having a program channel and an information channel, the receiver comprising:
a tuner, the tuner selecting a broadcast band;
a digitizer responsive to signal from the tuner, the digitizer providing a digital output of the selected broadcast channel; and
a processing unit responsive to the digital output of the digitizer, the processing unit separating the program channel from the information channel, the processing unit processing the information channel to identify a program type, the processing unit using the program type to identify selected parameters, the selected parameters being used to process the program channel.

11. The receiver as recited in claim 10 further comprising a speaker, the speaker responsive to signals from the processing unit providing the user with processed program material.

12. The receiver as recited in claim 11 wherein the processed program material is an audio program.

13. The receiver as recited in claim 10 further comprising a speaker, the processed program material being applied to the speaker.

14. The receiver as recited in claim 10 wherein each unit of program material has a program type transmitted therewith.
